(19) United States
(12) Patent Application Publication
(10) Pub. No.: US 2012/0246214 A1
(43) Pub. Date: Sep. 27, 2012

(54) METHOD FOR SUPPORTING SERVICE SETTING

(75) Inventors: Yukio Ogawa, Tokyo (JP); Shinsuke Takahashi, Yokohama (JP); Hiroki Miyamoto, Fujisawa (JP)

(73) Assignee: Hitachi, Ltd., Tokyo (JP)

(21) Appl. No.: 13/498,477

(22) PCT Filed: Feb. 4, 2010
(86) PCT No.: PCT/JP2010/000681

§ 371 Date: Jun. 8, 2012

(30) Foreign Application Priority Data
Nov. 2, 2009 (JP) 2009-251596

(51) Int. Cl. G06F 15/16

(52) U.S. Cl. 709/201

(57) ABSTRACT

In the disclosed method for supporting the setting of a service, an allocation set that designates the allocation of a program to an information processing device is generated, the service response time and the consumed system power during use of each allocation set are calculated, and from these evaluation results, an allocation set that meets a standard service response time and reduces consumed system power is selected.

### INCORPORATION BY REFERENCE

The present application claims priority from Japanese application JP2009-251596 filed on Nov. 2, Heisei 21 (2009), the content of which is hereby incorporated by reference into this application.

### TECHNICAL FIELD

The present invention relates to a service configuration support method in a case in which services are provided by use of information processing devices distributively deployed in a wide-area network system, and in particular, to a method of supporting allocation of application programs to information processing devices.

### BACKGROUND ART

As a technique in which caches (copies of data and application programs) are allocated to information processing devices distributively deployed in a wide-area network system to improve the service response time and to reduce the network traffic, there exists a contents delivery network (reference is to be made to, for example, patent literature 1).

Also, as a technique in which calculation resources (CPU, memories, hard disks) possessed by a plurality of information processing devices distributively deployed in a wide-area network system are used as one composite calculation resource, there exists grid computing (reference is to be made to, for example, patent literature 2).

### CITATION LIST

### Patent Literature

Patent literature 1: U.S. Pat. No. 7,376,716 Specification
Patent literature 2: U.S. Patent Application Publication 2005/0131993 Specification

### SUMMARY OF INVENTION

### Technical Problem

In the technique described in patent literature 1, no consideration has been given to a situation in which the main constituent component of the services includes a plurality of application programs and they are allocated to a plurality of information processing devices.

Hence, in a case in which the main constituent component of the services includes a plurality of application programs and they are allocated to a plurality of information processing devices, it is likely that the improvement of the service response time and the reduction of the network traffic cannot be coped with.

Additionally, in the technique described in patent literature 1, if it is desired to implement the improvement of the service response time and the reduction of the network traffic, it may occur that power is excessively consumed in the overall system.

In the technique described in patent literature 2, although the calculation resources possessed by the information processing devices are taken into consideration, the application programs are not allocated in consideration of the service response time. Hence, the service response time may become longer. Also, in a case in which the calculation resources possessed by the respective information processing devices are used, it is likely, since the power consumption of the overall system is not taken into consideration, that power is excessively consumed in the overall system.

### Solution to Problem

The present invention is devised in consideration of the problems above and provides a service configuration support method in which it is possible to allocate a plurality of application programs as the main constituent component of the services to the respective information processing devices so that the services in the mode described above are provided while satisfying the desired service response time as a criterion in consideration of reduction of the power consumption of the overall system.

In the present description, there is disclosed a technique to provide services implemented through operation in which information processing devices distributively deployed in a network cooperatively conduct operations to call application programs of a plurality of information processing devices to thereby process information, while satisfying the desired service response time in consideration of the system power consumption.

That is, in the present description, there is disclosed a technique in which a plurality of application programs as the main constituent component of the services are allocated to the information processing devices distributively deployed in a wide-area network in consideration of the service response time.

A management device according to one aspect disclosed is characterized by creating, when services implemented by sequentially calling a plurality of application programs to thereby process information are introduced to information processing devices geographically distributively deployed in a wide-area network system, an allocation set list of application programs to the information processing devices, calculating the service response time and the system power consumption when each allocation set of the list is applied, evaluating results of the calculation, and selecting allocation sets which satisfy the desired service response time and which reduce the system power consumption as a criterion or presenting selection candidates thereof.

Further, the management device is characterized by calculating the system operation step count in addition to the service response time and the system power consumption, evaluating results of the calculation, and selecting allocation sets which satisfy the desired service response time and which reduce the system power consumption and the system operation step count as a criterion or presenting selection candidates thereof.

In addition, the management device is characterized by selecting alternative allocation sets in a case in which it is feared that after the service is introduced, the desired service response time as the criterion is not satisfied.

Incidentally, a service in the present description indicates providing a user or a third party with results of information processing in a recognizable form or controlling devices associated with a user or a third party according to results of information processing.

### Advantageous Effects of Invention

According to the present invention, it is possible to provide services, implemented through operation in which information processing devices distributively deployed in a network system cooperatively conduct operations, by using a small amount of power consumption and a short response time.

### BRIEF DESCRIPTION OF DRAWINGS

FIG. 1 is a diagram to exemplify a general configuration of a network system in an embodying mode.

FIG 2 is a diagram to exemplify a hardware configuration of a management device in an embodying mode.

FIG. 3 is a diagram to exemplify a functional configuration of services in an embodying mode.

FIG. 4 is a diagram to exemplify a functional configuration of a management device in an embodying mode.

FIG. 5 is an example of a service attribute managing table in an embodying mode.

FIG. 6 is an example of an information processing device managing table in an embodying mode.

FIG 7 is an example of an information processing device performance managing table in an embodying mode.

FIG. 8 is an example of a communication path managing table in an embodying mode.

FIG 9 is an example of a table for managing links between information processing devices and communication paths in an embodying mode.

FIG. 10 is an example of a table for managing power consumption of information processing devices in an embodying mode.

FIG 11 is an example of a table for managing power consumption of communication paths in an embodying mode.

FIG. 12 is an example of a table for managing application program allocation sets in an embodying mode.

FIG. 13 is an example of a table for managing allocation of application programs in an embodying mode.

FIG. 14 is an example of a table for managing communication paths for services in an embodying mode.

FIG. 15 is an example of a flowchart showing processing of a management device in an embodying mode.

FIG. 16 is a flowchart exemplifying allocation template preparation processing in an embodying mode.

FIG. 17 is an example of an allocation template in an embodying mode.

FIG. 18 is an example of an application program allocation set list in an embodying mode.

FIG 19 is a flowchart exemplifying allocation set evaluation processing in an embodying mode.

FIG. 20 is a display example of a service response time evaluation graph in an embodying mode.

FIG. 21 is a display example of a system power consumption evaluation graph in an embodying mode.

FIG. 22 is a display example of a system operation step count evaluation graph in an embodying mode.

### DESCRIPTION OF EMBODIMENTS

Next, description will be given of an embodying mode of the present invention by referring to the drawings. Incidentally, the same reference numerals assigned in the respective diagrams represent the same items or the corresponding items. Also, similar items are discriminated by adding subscripts to the reference numerals thereof depending on cases for convenience of explanation.

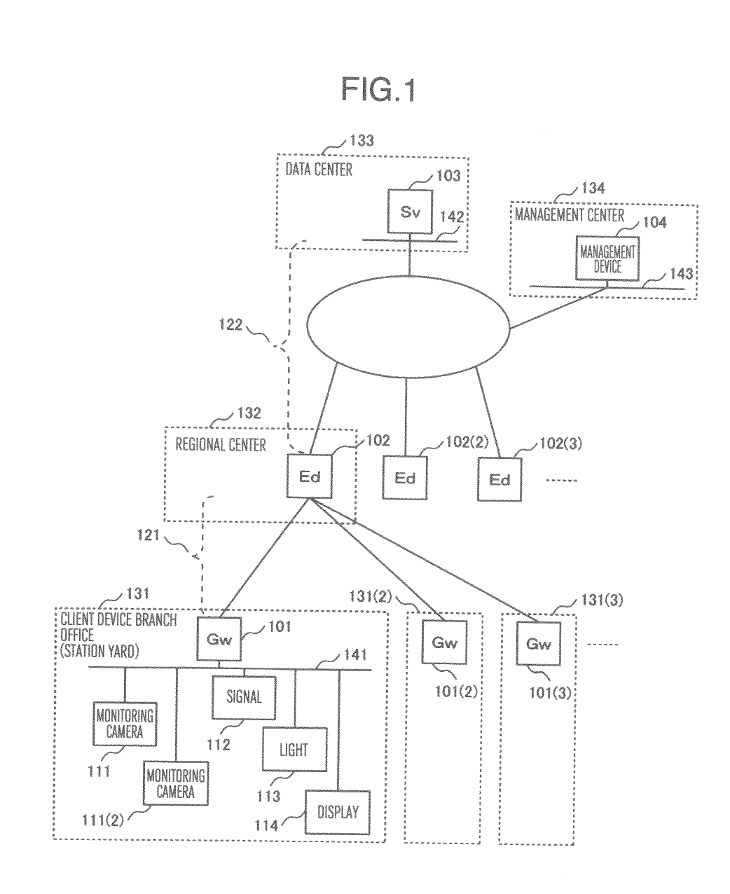

Description will be given of an outline of a network system configuration to which an embodying mode of the present invention is applied, by referring to FIG. 1. As shown, the network system of the embodying mode is configured such that client devices installed at a plurality of branch offices for client devices 131 are coupled via a regional center 132 with a server device 103 installed in a data center 133. In more detail, the client devices are coupled via a branch office network 141 and a gateway node 101 in the client device branch office 131 and an access network 121 with an edge node 102 installed in the regional center 132, and are further coupled via an edge node 102, a backbone network 122 of the nationwide scale, and a data center network 142 in the data center 133 with the server device 103.

Here, as examples of the client devices installed in the client device branch office 131, there are shown a monitoring camera 111, a traffic signal device 112, a lighting device 113, and a display device 114.

Next, description will be given of an embodying mode by using, as an example, a service to control the traffic signal device 112, the lighting device 113, and the display device 114 by using images shot by use of the monitoring camera device 111. However, any client device and any service may be used only if the client device is in a mode to use a service provided by an information processing device.

The information processing devices constituting the network system of the embodiment are configured in three layers: the first-layer information processing device is the gateway node 101 installed in the client device branch office 131, the second-layer information processing device is the edge node 102 installed in the regional center 132, and the third-layer information processing device is the server device 103 installed in the data center 133.

The devices in the respective layers are arranged as the gateway node 101, the edge node 102, and the server device 103 in an ascending order of distance relative to the client device (for example, in an ascending network delay time order). Also, the relationship between the numbers of information processing devices in the respective layers satisfies “the number of gateway nodes 101>>”the number of edge nodes 102”>>“the number observer devices 103”.

Incidentally, for the embodiment below, description will be given of the three-layer configuration as an object; however, the contents of the embodying are not restricted by the number of layers; even if the second layer is further subdivided to implement a multilayer configuration, the embodiment is similarly applicable.

Subsequently, an information processing device indicates the gateway node 101, the edge node 102, or the server device 103. Also, in the present embodiment, the client device branch office 131 is a station yard as an example; however, it may also be other than the station yard.

Next, description will be given of each item of FIG 1.

In the client device branch office 131 (station yard), there are installed client devices such as the monitoring camera device 111, the traffic signal device 112, the lighting device 113, and the display device 114.

The monitoring camera device 111 is a video camera to monitor the station yard, continuously shoots images, and transfers image data via the branch office network 141 to the gateway node 101. The traffic signal device 112 is a device which controls signals when a person or a dangerous item falls onto the railroad, to notify the danger to an electric train or the like coming in the station yard. The lighting device 113 is a device to illuminate a passage or the like in the station yard. The display device 114 is a device to display information of operation, a yard service guide, and an advertisement. The branch office network 141 is a network which couples the monitoring camera device 111, the traffic signal device 112, the lighting device 113, and the display device 114 in the client device branch office 131 (station yard) with each other to transfer data through wired communication or wireless communication. In the branch office network 141, the communication is conducted according to the standard stipulated by IEEE802.3 or the like.

The gateway node 101 is an information processing device including a data transfer function and a data processing function (application program executing function) at service execution. The gateway node 101 couples the branch office network 141 with the access network 121. In the description below, the gateway node 101 is represented as “Gw” in some cases. The gateway node 101 processes the image data outputted from the monitoring camera device 111 to transfer the data to the access network 121. Also, it transmits control data to the traffic signal device 112, the lighting device 113, and the display device 114.

The access network 121 and the backbone network 122 are a communication network and an aggregate of a plurality of communication paths including information communicating devices such as a router and a switch, not shown, as well as communication lines coupling them with each other.

The backbone network 122 is a trunk communication network extending in a wide area such as a range of one nation. The backbone network 122 and the access network 121 configure a layered network topology capable of accommodating a large number of locations. In the respective networks, Internet Protocol (IP) packets are transferred.

The access network 121 is a communication network to couple the gateway node 101 installed in the client device branch office 131 with the edge node 102 installed in the regional center 132.

The regional center 132 is a location to install the edge node 102 to accommodate a plurality of gateway nodes 101 and the access network 121. One regional center 132 is installed in each ward or city (or a part thereof) or in each area formed by combining them with each other.

The edge node 102 is an information processing device including a data transfer function and a data processing function (application program executing function) at service execution. The edge node 102 is placed between the access network 121 and the backbone network 122. Hereinbelow, the edge node 102 is represented as “Ed” in some cases.

in the data center 133, the server device 103 is installed. The server device 103 is an information processing device including a data processing function (application program executing function) at service execution. The server device 103 couples via the data center network 142 with the backbone network 122. Hereinbelow, the server device 103 is represented as “Sv” in some cases.

In a management center 134, the management device 104 is installed. The management device 104 couples via a management center network 143 with the backbone network 122. The management device 104 is a device to manage the gateway node 101, the

edge node 102, and the server device 103.

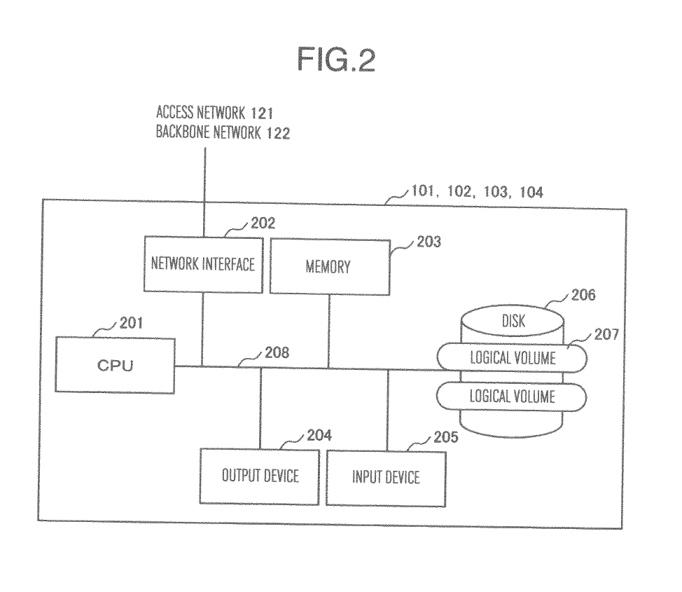

Next, description will be given of a hardware configuration of the management device 104 in an embodying mode of the present invention by referring to FIG. 2.

The management device 104 includes a CPU 201, a memory 203, a network interface 202, a disk 206, and an internal signal line 208. Also, the management device 104 includes an output device 204 and an input device 205 to execute interactive processing with a manager.

In the management device 104, under control of an Operating System (OS), the CPU 201 calls programs stored in the disk 206 into the memory 203 and executes the programs to thereby implement respective functions, which will be described below. However, in the description below, each program is regarded as the main constituent component of the execution, for convenience.

The CPU 201 is a processor which executes programs called into the memory 203 to thereby conduct various processing.

The memory 203 is, for example, a volatile or nonvolatile memory for which high-speed access is possible, and stores programs to be executed by the CPU 201 and information or the like required for the CPU 201.

The network interface 202 includes a network interface card such as an IEEE802.3 interface card corresponding to various communication speeds such as 1 Gps and 10 Gps, and functions as a data input and output adapter to couple via a communication network with an information processing device facing thereto. The network interface 202 sends and receives data and control signals based on TCP/IP and the like.

The disk 206 is a storage device, for example, a Serial Advanced Technology Attachment (SATA) disk drive, a Serial Attached SCSI (SAS) disk drive, or a Small Computer System Interface (SCSI) disk drive. The disk 206 may be a nonvolatile semiconductor memory. The nonvolatile semiconductor memory is, for example, a flash memory. In the disk 206, a plurality of logical volumes 207 are set to store therein an OS, an application program, and various information pieces such as user data.

Incidentally, each program and data may be beforehand stored in the disk 206 or may be introduced, according to necessity, from another device into the disk 206 via the network interface 202, a recording medium, reader device, not shown, and a medium which is available for the management device 104. The medium indicates a storage medium attachable to and detachable from the recording medium reader device or a communication medium (that is, wired, wireless, and optical networks or carrier waves and digital signals which propagate through the network).

The internal signal line 208 is, for example, a bus. The internal signal line 208 couples the CPU 201, the memory 203, the network interface 202, the disk 206, the input device 205, and the output device 204 with each other.

The output device 204 is a device to display various information pieces and is, for example, a display device.

The input device 205 is a device for the manager to input various information pieces and is, for example, a keyboard or a mouse.

The gateway node 101, the edge node 102, and the server device 103 are also similar in the hardware configuration to the management device 104; however, if it is not required to conduct interactive processing with the manager, the output device 204 and the input device 205 may be dispensed with. Further, in the gateway node 101 and the edge node 102, a plurality of network interfaces 202 may be disposed.

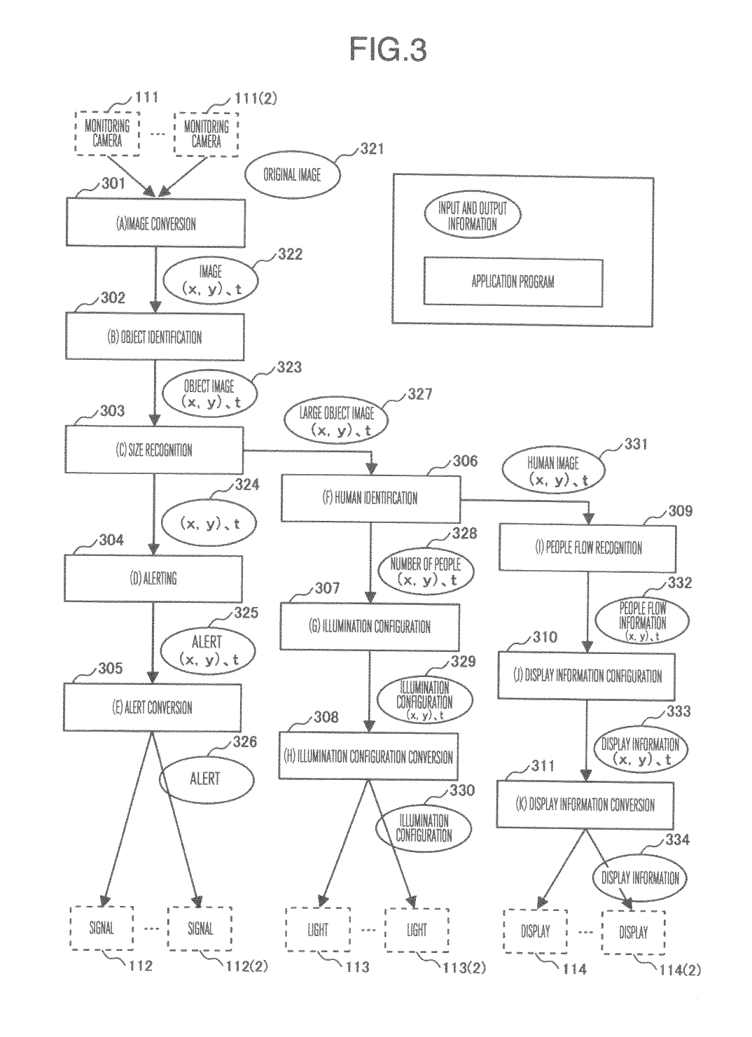

Next, description will be given of services exemplified in the present embodying mode by referring to FIG. 3. Here, description will be given of an example of services to control the traffic signal device 112, the lighting device 113, and the display device 114 in the client device branch office 131 (station yard) by use of images shot by using the monitoring camera device 111.

This service is configured by combining several application programs with each other. That is, “each application program receives data from an application program in the preceding stage, executes processing, and then passes data to an application program in the succeeding stage” is repeatedly carried out, to thereby implement the service.

The data passed between the application programs may be described according to, for example, the Extensible Markup Language (XML) format; however, the data may be described in any format only if the application program to receive the data is capable of interpreting the format. The application program is a Web service in which, for example, Simple Object Access Protocol (SOAP) over Hypertext Transfer Protocol (HTTP) is employed as the communication protocol; however, it may be a database query using SQL.

Incidentally, in the example shown in FIG. 3, “program” to be added to the end of the name of the application program is omitted. Moreover, in the parentheses at the top of the application program name, an ID (ID501 of a service attribute managing table 500) of the application program, which will be described later, is described.

Next, description will be given of processing to control the traffic signal device 112 by using images shot by the monitoring camera device 111.

To measure the response time of the service, an image conversion program 301 measures the input time of an unprocessed original image 321, and outputs the input time of the original image 321 in addition to data of images and the like to an application program in the succeeding stage.

The monitoring camera device 111 transmits a fixed number of sheets of the original image 321 per unitary time (for example, ten sheets per second) to the image conversion program 301.

The image conversion program 301 adds, on receiving the original image 321, the identifier (ID) of the monitoring camera device 111 as attribute information to the original image 321. Incidentally, the original image 321 conforms to an image format unique to the monitoring camera device 111. Also, the image conversion program 301 records the input time (t) of the original image 321.

The image conversion program 301 converts the original image 321 received from the monitoring camera device 111 into an image 322 of a standard image format so that the application program in the succeeding stage processes it, and then converts the ID of the monitoring camera device 111 into camera position coordinates ((x,y)). The image conversion program 301 transmits the image 322, the camera position coordinates ((x,y)), and the input time (t) of the original image 321 to an object identification program 302 in the succeeding stage.

The object identification program 302 executes image processing for the received image 322 to determine whether or not the image 322 includes a mobile object. The image processing to identify the mobile object is implemented by using a combination of image analysis algorithms such as the threshold value processing, the edge detection processing, and the area division processing described in “The Pocket Handbook of Image Processing Algorithms In C” (written by H. R. Myler and A. R. Weeks; Prentice Hall, Inc., 1993, ISBN: 978-0136422402) and the like,

The identification of the mobile object may be realized by processing a single image 322 or by processing a plurality of images 322 at different input points of time (t) of the original image 321. This also applies to image processing in a size recognition program 303, a human identification program 306, and a people flow recognition program 309, which will be described later.

The object identification program 302 transmits, if the image 322 includes a mobile object, its image (object image 323) together with the camera position coordinates ((x,y)) to the size recognition program 303. Also, it transfers the input time (t) of the corresponding original image 321.

The size recognition program 303 executes image processing for the received object image 323 to determine whether or not the size of the mobile object is equal to or more than a threshold value. If the size of the mobile object is equal to or more than the threshold value, the size recognition program 303 transfers the camera position coordinates ((x,y)) 324 of the pertinent object image 323 to an alerting program 304. Also, the size recognition program 303 transfers the input time (t) of the original image 321.

The alerting program 304 determines, based on the received camera position coordinates ((x,y)) 324, whether or not an alert is to be indicated. If the alert is to be indicated, the alerting program 304 transmits an alert 325 together with the camera position coordinates ((x,y)) 324 to an alert conversion, program 305. Also, it transfers the input time (t) of the original image 321.

The alert conversion program 305 converts the received alert 325 into data of an alert format unique to the traffic signal device 112 so that the traffic signal device 112 processes the data. Further, the program 305 obtains, based on the camera position coordinates ((x,y)) 324, the ID of the traffic signal device 112 which issues the alert. The alert conversion program 305 transmits the alert 326 to the traffic signal device 112 indicated by the ID. The traffic signal device 112 notifies, according to the received alert, the danger to the periphery by use of light, sound, vibration, or the like.

The alert conversion program 305 measures the time at which the alert 326 is transmitted to the traffic signal device 112. By obtaining the difference between this time and the input time (t) of the original image 321, the program 305 measures the service response time.

Next, description will be given of processing to control the lighting device 113 by use of images shot by the monitoring camera device 111. The processing ranging from the image conversion program 301 to the size recognition program 303 is as described above.

The human identification program 306 executes image processing for a large object image 327 received from the size recognition program 303 to determine whether or not the object of the size equal to or more than the threshold value includes a human and to determine an approximate number of humans. If the object includes a human, the program 306 transmits the number of humans (approximate number) and the camera position coordinates ((x,y)) 328 to an illumination configuration program 307. Also, the program 306 transfers the input time (t) of the original image 321.

The illumination configuration program 307 determines, based on the number of humans and the camera position coordinates ((x,y)) 328 thus received, whether or not the lighting device 113 is to be set and determines, if the lighting device 113 is to be set, the illumination configuration (illumination on or off, illumination brightness). The illumination configuration program 307 transmits, if the lighting device 113 is to be set, the illumination configuration 329 together with the camera position coordinates ((x,y)) to an illumination configuration conversion program 308. Also, the program 307 transfers the input time (t) of the original image 321.

The illumination configuration conversion program 308 converts the received illumination configuration 329 into data of an illumination configuration format unique to the lighting device 113 so that the lighting device 113 processes the data. Moreover, the illumination configuration conversion program 308 obtains, based on the camera, position coordinates ((x,y)) 324, the ID of the lighting device 113 for which the illumination configuration is to be implemented.

The illumination configuration, conversion program 308 transmits an illumination configuration 330 to the lighting device 113 indicated by the ID. The lighting device 113 puts the illumination on or off and changes the brightness according to the received illumination configuration 330.

The illumination configuration conversion program 308 measures the time at which the illumination configuration is transmitted to the lighting device 113. By obtaining the difference between this time and the input time (t) of the original image 321, the program 308 measures the service response time.

Next, description will be given of processing to control the display device 114 by use of images shot by the monitoring camera device 111. The processing ranging from the image conversion program 301 to the size recognition program 303 as well as to the human identification program 306 is as described above.

The people flow recognition program 309 executes image processing for one sheet or a plurality of sheets of a human image 331 received from the human identification program 306, to measure people flow information. The people flow information includes a direction of a flow of people and the number of humans in the image. When the people flow information is measured, the program 309 transmits people flow information 332 and the camera position coordinates ((x,y)) to a display information configuration program 310. Also, it transfers the input time (t) of the original image 321.

The display information configuration program 310 determines, based on the people flow information 322 and the camera position coordinates ((x,y)) thus received whether or not the display device 114 is to be set, and determines, if the display device 114 is to be set, display information (information of operation, a service guide and an advertisement in the station yard). If the display device 114 is to be set, the program 310 transmits display information 333 together with the camera position coordinates ((x,y)) to a display information conversion program 311. Also, it transfers the input time (t) of the original image 321.

The display information conversion program 311 converts the received display information 333 into data of a display information format unique to the display device 114 so that the display device 114 processes the data. Further, based on the camera position coordinates ((x,y)), the program 311 obtains the ID of the display device 114 for which the display information is set. The display information conversion program 311 transmits display information 334 to the display device 114 indicated by the ID. The display device 114 displays the received display information 334.

The display information conversion program 311 measures the time at which the display information is transmitted to the display device 114. By obtaining the difference between this time and the input time (t) of the original image 321, the program 311 measures the

service response time.

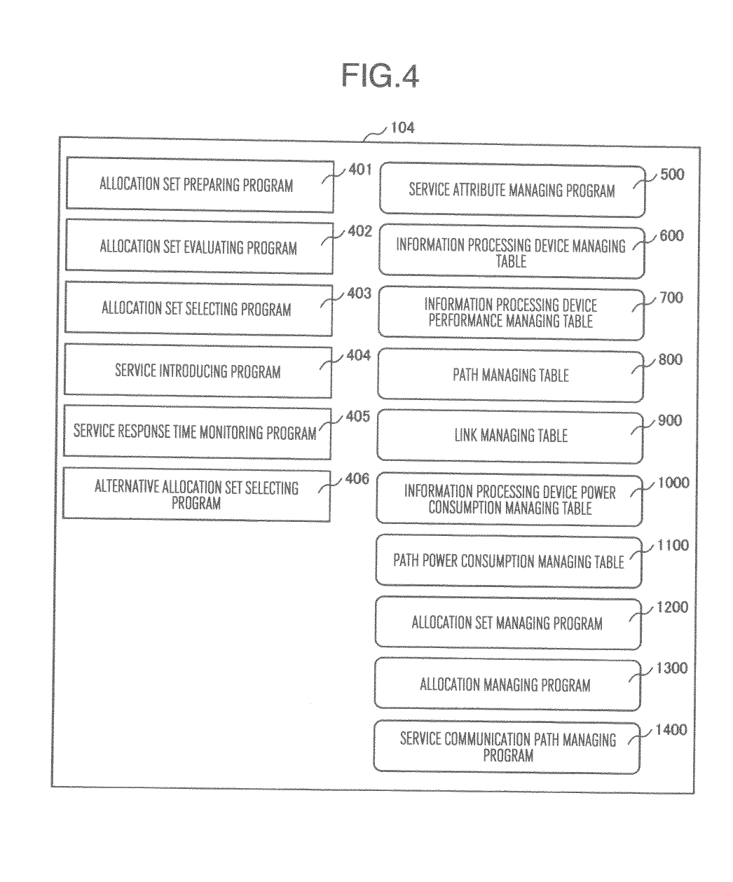

Next, description will be given of a functional configuration of the management device 104 in the present embodying mode by referring to FIG. 4. Programs and management tables possessed by the management device 104 are stored in the disk 206 disposed in the management device 104 and are called into the memory 203 to be executed or processed by the CPU 201.

The management device 104 includes respective programs such as an allocation set preparing program 401, an allocation set evaluating program 402, an allocation set selecting program 403, a service introducing program 404, a service response time monitoring program 405, and an alternative allocation set selecting program 406 as well as respective management tables such as a service attribute managing table 500, an information processing device managing table 600, an information processing device performance managing table 700, a path managing table 800, a link managing table 900, an information processing device power consumption managing table 1000, a path power consumption managing table 1100, an allocation set managing table 1200, an allocation managing table 1300, and a service communication path managing table 1400. The respective management tables are implemented by techniques such as a relational database.

Next, description will be given of a configuration of the management tables possessed by the management device 104. In the description of each column of the management tables, description of units will be avoided. Further, the contents of inputs to the respective management tables are indicated by the manager. Incidentally, processing of each program and a use example of each management table will be described later.

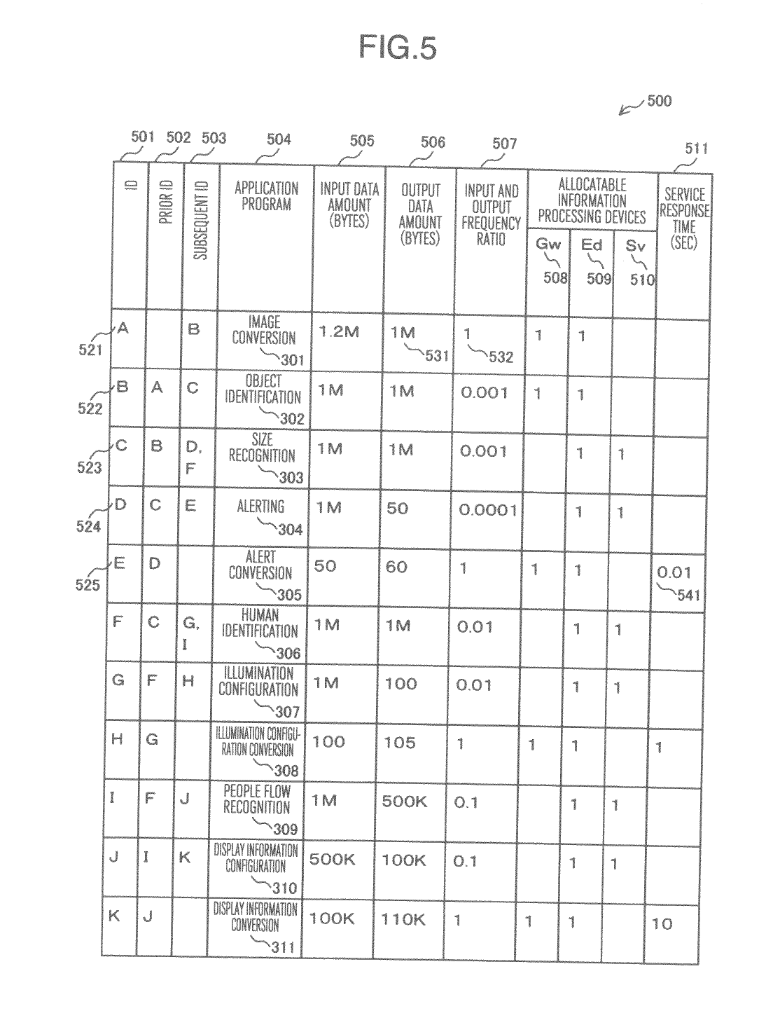

FIG. 5 shows a configuration of the service attribute managing table 500 for the management device 104 to control attributes of the station yard monitoring services exemplified in FIG. 3. The service attribute managing table 500 is created for each service.

The service attribute managing table 500 includes respective columns such as an identifier (ID) column 501, a prior ID column 502, a subsequent ID column 502, an application program column 504, an input data amount column 505, an output data amount column 506, an input and output frequency ratio column 507, an allocatable information processing device column (508 column, 509 column, 510 column), and a service response time column 511.

To the ID column 501, there is inputted the identifier of an application program to be managed by the service attribute managing table 500. This is the main key of the service attribute managing table 500. Here, capital letters of the Roman alphabet are assigned in the alphabetical order as “A”, “B”, “C”, . . . .

To the prior ID column 502, there is set the identifier of an application program to output data which is received as an input by the pertinent application program.

To the subsequent ID column 503, there is set the identifier of an application program to receive, as an input thereto, data outputted from the pertinent application program.

Incidentally, an application program in the first stage (for which the prior ID column 502 is not defined) to start a series of processing of the service is called a service start application program. In the present embodiment, this corresponds to the image conversion program 301.

Further, an application program in the last stage (for which the subsequent ID column 503 is not defined) to end a series of processing of the service is called a service end application program. In the present embodiment, this corresponds to the alert conversion program 305, the illumination configuration conversion program 308, and the display information conversion program 311.

A program corresponding neither to the start application program nor to the end application program described above is called an intermediate application program of the service. In the present embodiment, this corresponds to the object identification program 302, the size recognition program 303, the alerting program 304, the human identification program 306, the illumination configuration program 307, the people flow recognition program 309, and the display information configuration program 310.

To the application program column 504, the name of an application program is set. In the example shown in FIG. 5, “program” to be added to the end of the name is omitted.

If the size of the input data is a fixed value, the size is registered to the input data

amount column 505.

If the size of the output data is a fixed value, the size is registered to the output data amount column 506.

To the input and output frequency ratio column 507, there is set the ratio (probability) of the number of data outputs to that of the data inputs. For example, if the output is conducted according to the probability of one data output to ten data inputs, the ratio is 0.1.

The allocatable information processing device column (Gw 508 column, Ed 509 column, Sv 510 column) indicates the type of an information processing device to which the pertinent application program is allocatable. If the gateway node 101 is an allocatable information processing device, “1” is set to Gw 508 column. If the edge node 102 is an allocatable information processing device, the lid 509 column is set in a similar way. If the server device 103 is an allocatable information processing device, the Sv 510 column is set in a similar way.

The determination of which one of the programs is allocatable to which one of the types of information processing devices is conducted by the manager in consideration of the processing load and the contents of processing of each application program. For example, when handling information of each client device, the gateway node 101 is regarded as allocatable; in a situation of the large processing load, the edge node 102 and the server device 103 are regarded as allocatable.

To the service response time column 511, a service response time required at service execution is set if the pertinent application program is the end application program.

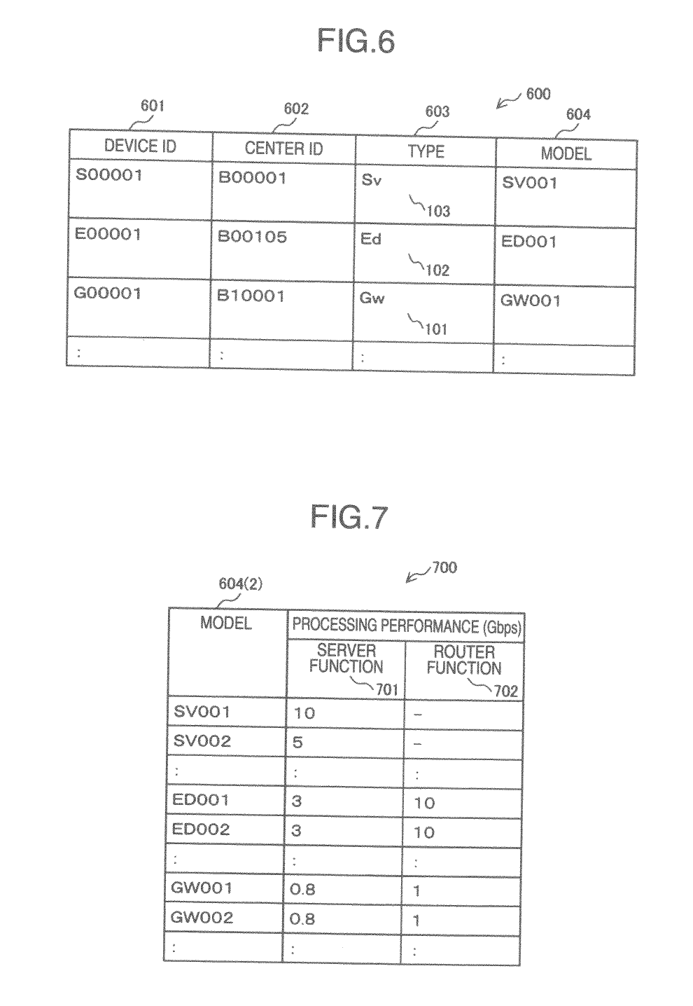

Next, description will be given of the information processing device managing table 600 for the management device 104 to control the information processing devices by referring to FIG 6.

The information processing device managing table 600 includes respective columns such as a device ID column 601, a location ID column 602, a type column 603, and a model column 604.

To the device ID column 601, the ID (identifier) of an information processing device is set. This is the main key of the information processing device managing table 600.

To the location ID column 602, there is set the ID (identifier) of the location at which the pertinent information processing device is installed.

To the type column 603, the type of the information processing device is set. For the gateway node 101, the edge node 102, and the server device 103, there are respectively set “Gw”, “Ed”, and “Sv”.

To the model column 604, the device model of the information processing device (an identifier of the product model) is set.

Next, description will be given of the information processing device performance managing table 700 for the management device 104 to control performance of the information processing devices by referring to FIG. 7.

The information processing device performance managing table 700 includes respective columns such as a model column 604(2), a processing performance column 701 regarding server functions, and a processing performance column 702 regarding router functions.

The model column 604(2) is similar to the model column 604 of the information processing device managing table 600. This is the main key of the information processing

device performance managing table 700.

To the processing performance column 701 regarding server functions, there is set processing performance (throughput) when the pertinent information processing device executes processing of application programs. If the processing performance varies between types of application programs, a mean value is set. Or, a minimum value may be set.

To the processing performance column 702 regarding router functions, there is set processing performance (throughput) when the information processing device transfers data without executing processing of application programs.

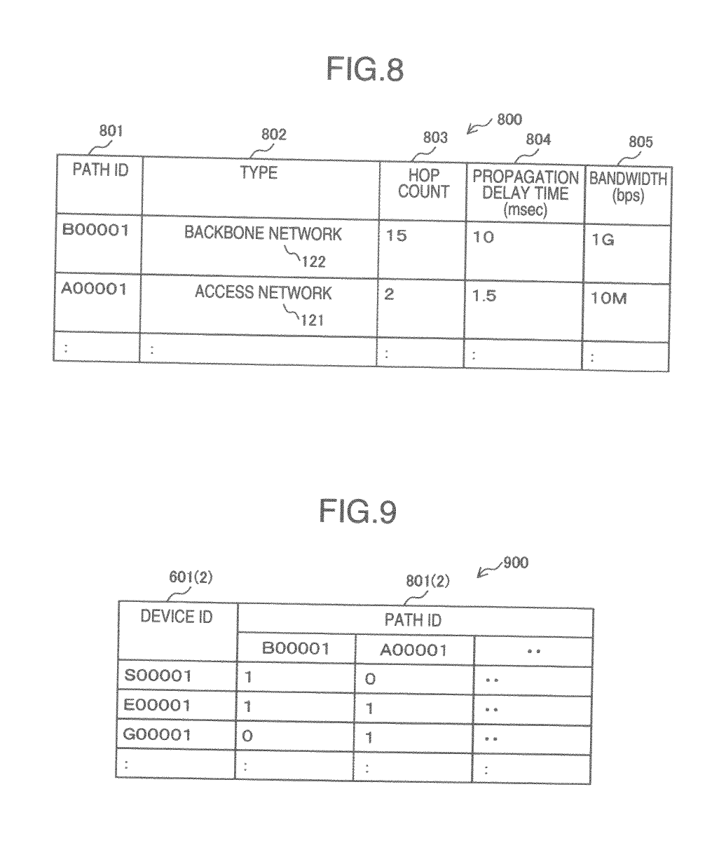

Next, description will be given of the path managing table 800 for the management device 104 to control paths between information processing devices by referring to FIG 8.

The paths managed by the path managing table 800 are paths to directly couple the information processing devices with each other. The paths include, for example, a path to couple information processing device A with information processing device B without using any other information processing device. A path to couple information processing device A via information processing device C with information processing device B are managed by dividing the path into a path to couple information processing device A with information processing device C without using any other information processing device and a path to couple information processing device C with information processing device B without using any other information processing device.

Incidentally, the paths may be virtual paths realized by the Virtual Private Network (VPN) technology and the like.

The path managing table 800 includes respective columns such as a path ID column 801, a type column 802, a hop count column 803, a propagation delay time column 804, and a bandwidth column 805.

To the path ID column 801, the ID (identifier) of a path is set. This is the main key of the path managing table 800. To the type column 802, there is set the type of the path, namely, the network (the backbone network 122 or the access network 121) to which the path belongs.

To the hop count column 803, there is set the number of communication devices such as routers and switches existing on the pertinent path.

To the propagation delay time column 804, there is set a period of time from when data is transmitted from an information processing device via the path to when the data arrives at another information processing layer.

To the bandwidth column 805, a bandwidth available for the path is set. If the bandwidth changes in the path, a minimum value thereof is set.

Next, description will be given of the link managing table 900 for the management device 104 to control linkage relationships between information processing devices and paths by referring to FIG. 9.

The link managing table 900 includes a device ID column 601(2) and a path ID 801(2) column.

The device ID column 601(2) is similar to the device ID column 601 of the information processing device managing table 600. This is the main key of the link managing table 900.

The path ID 801(2) column includes respective columns of values of the path ID column 801 in the path managing table 800. If an information processing device indicated by the pertinent device ID couples with the path indicated by the path ID, “1” is set; otherwise, “0” is set.

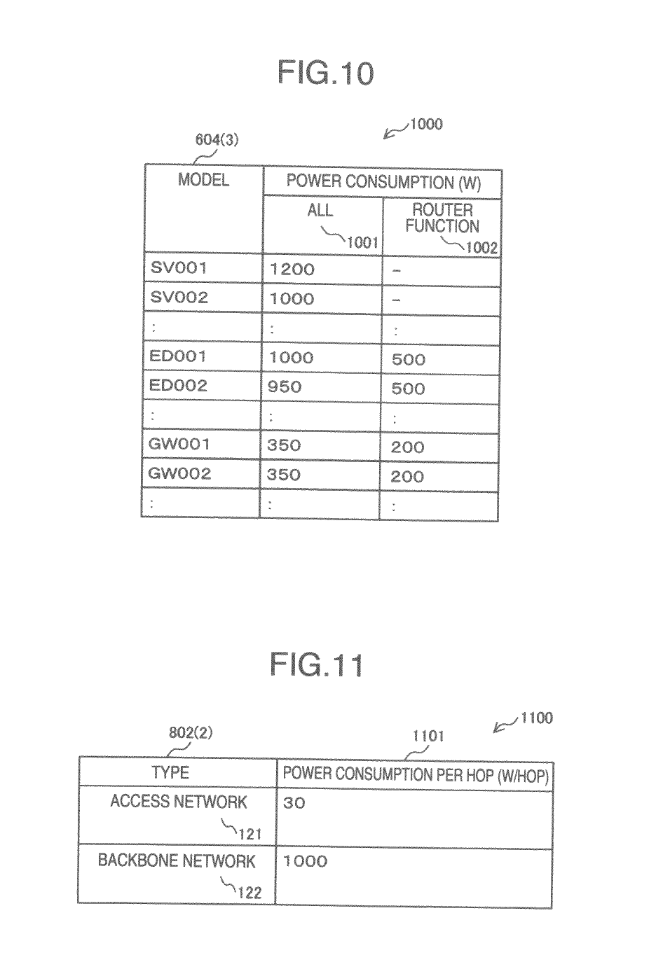

Next, description will be given of the information processing device power consumption managing table 1000 for the management device 104 to control power consumption of information processing devices by referring to FIG. 10.

The information processing device power consumption managing table 1000 includes respective columns such as a model column 604(3), an all power consumption column 1001, and power consumption 1002 regarding router functions.

The model column 604(3) is similar to the model column 604 of the information processing device managing table 600. This is the main key of the information processing device power consumption managing table 1000.

To the all power consumption column 1001, there is set power consumed when the pertinent information processing device is executing application programs. If the power varies depending on processing amounts of application programs, there is set power consumed for an average processing amount. Or, there may be set power consumed when the processing amount is at the upper limit.

To the power consumption 1002 regarding router functions, there is set power consumed when the pertinent information processing device transfers data without executing

processing of application programs.

Next, description will be given of the path power consumption managing table 1100 for the management device 104 to control power consumption of paths by referring to FIG. 11.

The path power consumption managing table 1100 includes respective columns such as a type column 802(2) and a one-hop power consumption column 1101.

The type column 802(2) is similar to the type column 802 of the path managing table 800. This is the main key of the path power consumption managing table 1100.

To the one-hop power consumption column 1101, there is set power consumed each time one hop (one communication device) is passed in the path of the pertinent type.

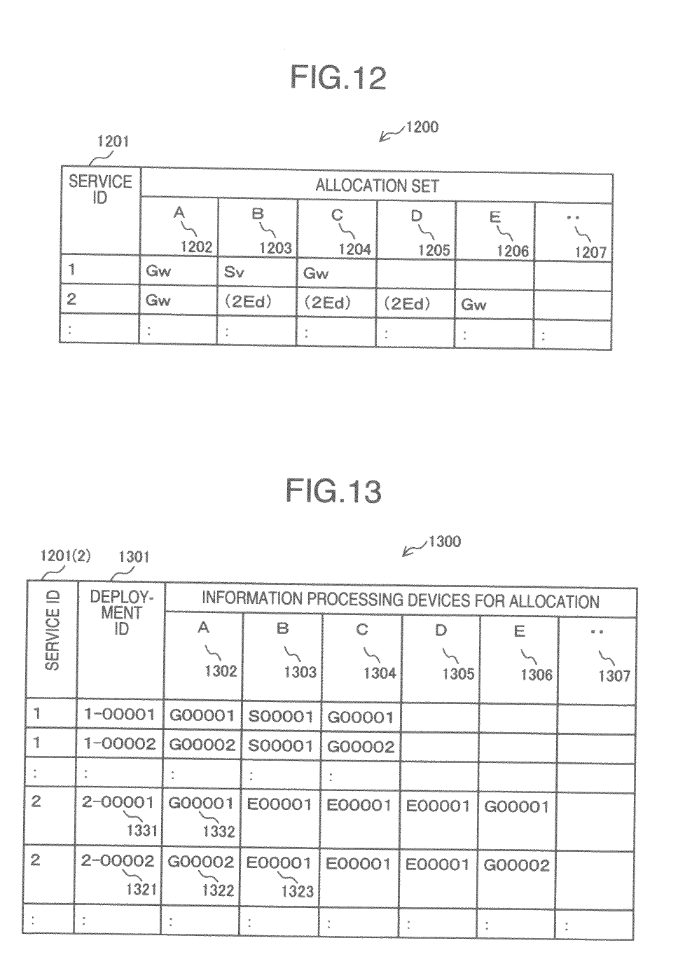

Next, description will be given of the allocation set managing table 1200 for the management device 104 to control an allocation set of application programs constituting a service by referring to FIG 12.

In the present embodiment, a service includes a combination of a plurality of application programs, and each application program is allocated to either one of three types of information processing devices (the gateway node 101, the edge node 102, the servicer device 103).

An allocation set is a combination of allocation of application programs (which one of application programs is allocated to which one of the types of information processing devices) when a service is implemented.

The allocation set managing table 1200 includes a service ID column 1201 and an allocation set column (1202 column-1207 column).

To the service ID column 1201, the identifier (ID) of a service is set. This is the main key of the allocation set managing table 1200.

The allocation set column includes respective columns (1202 column-1207 column) of application program IDs associated with the pertinent service. To each column, there is set the type of an information processing device to which the application program indicated by the ID is allocated.

When the pertinent application program is allocated to one gateway node 101 in this ratio, “Gw” is set. When the application program is allocated to one server device 103 in this ratio, “Sv” is set. When the application program is allocated to one edge node 102 in this ratio, “Ed” is set. When the application program is allocated to every x-th edge node 102 in this ratio, “(xEd)” is set. For example, when the application program is allocated to every second edge node 102 in this ratio, “(2Ed)” is set.

Next, description will be given of the allocation managing table 1300 for the management device 104 to control allocation of application programs constituting a service by referring to FIG. 13.

The allocation managing table 1300 is a table for the management device 104 to control, when each application program is allocated to an information processing device at implementation of a service according to the allocation managing table 1300, the allocation (which one of application programs is allocated to which one of the information processing devices).

The allocation managing table 1300 includes a service ID column 1201(2), a deployment ID column 1301, and an information processing devices for allocation column (1302 column-1307 column).

The service ID column 1201(2) is similar to the service ID column 1201 of the allocation set managing table 1200.

To the deployment ID column 1301, the identifier (ID) of the deployment (deploy, actual example) of the pertinent service is set. This is the main key of the allocation managing table 1300.

The information processing devices for allocation column includes respective columns (1302 column-1307 column) of application program IDs associated with the deployment. To each column, there is set the device ID (the device ID 601 of the information processing device managing table 600) of the information processing device to which the application program indicated by the ID is allocated.

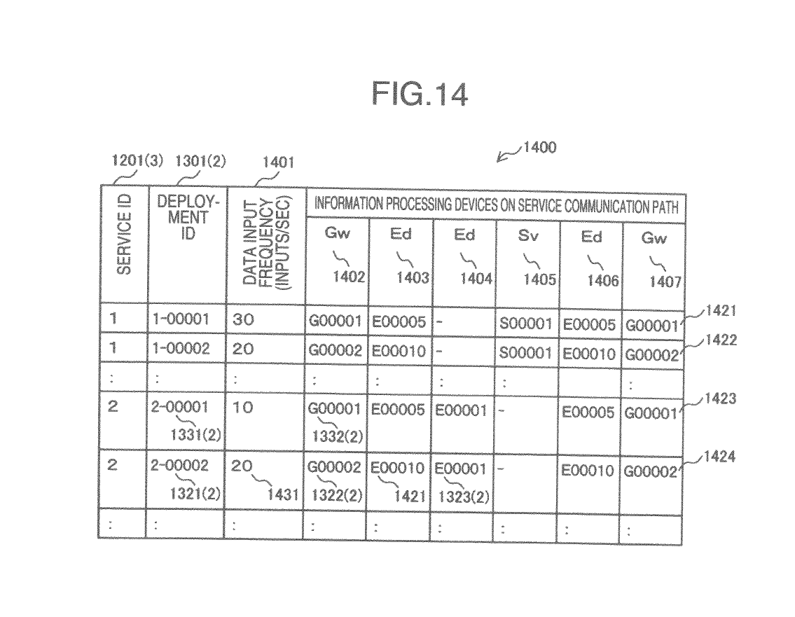

Next, description will be given of the service communication path managing table 1400 for the management device 104 to control communication paths at execution of a service by referring to FIG. 14.

The service communication path managing table 1400 is a management table for the management device 104 to control the information processing devices existing on the communication path at execution of a service.

The service communication path managing table 1400 includes a service ID 1201(3), a deployment ID 1301(2), a data input frequency 1401 column, and an information processing device column (1402 column-1407 column).

The service ID column 1201(3) is similar to the service ID column 1201 of the allocation set managing table 1200.

The deployment ID column 1301(2) is similar to the deployment ID column 1301 of the allocation managing table 1300. This is the main key of the service communication path managing table 1400.

To the information processing device column (1402 column-1407 column), there are set device IDs (the device ID column 601 of the information processing device managing table 600) of the information processing devices existing on the communication path associated with the deployment. In the present embodiment, as for the device configuration on the communication path, three configurations are assumed as below. Hence, in FIG. 14, the information processing device column is configured as indicated by (1402 column-1407 column) so that all deployments of information processing devices are registered in association with these three device configurations. However, the communication paths are not restricted by the configurations.
Device configuration 1: Gateway node 101 (“Gov” column 1402)—Edge node 102 (“Ed” column 1403)—Server device 103 (“Sv” column 1405)—Edge node 102 (“Ed” column 1406)—Gateway node 101 (“Gw” column 1407)
Device configuration 2: Gateway node 101 (“Gw” column 1402)—Edge node 102(2) (“Ed” column 1404)—Gateway node 101 (“Gw” column 1407)
Device configuration 3: Gateway node 101 (“Gw” column 1402)—Edge node 102 (“Ed” column 1403)—Edge node 102(2) (“Ed” column 1404)—Edge node 102 (“Ed” column 1406)—Gateway node 101 (“Gw” column 1407)

In FIG 14, a 1421 row and a 1422 row are examples of device configuration 1, and a 1423 row and a 1424 row are examples of device configuration 3.

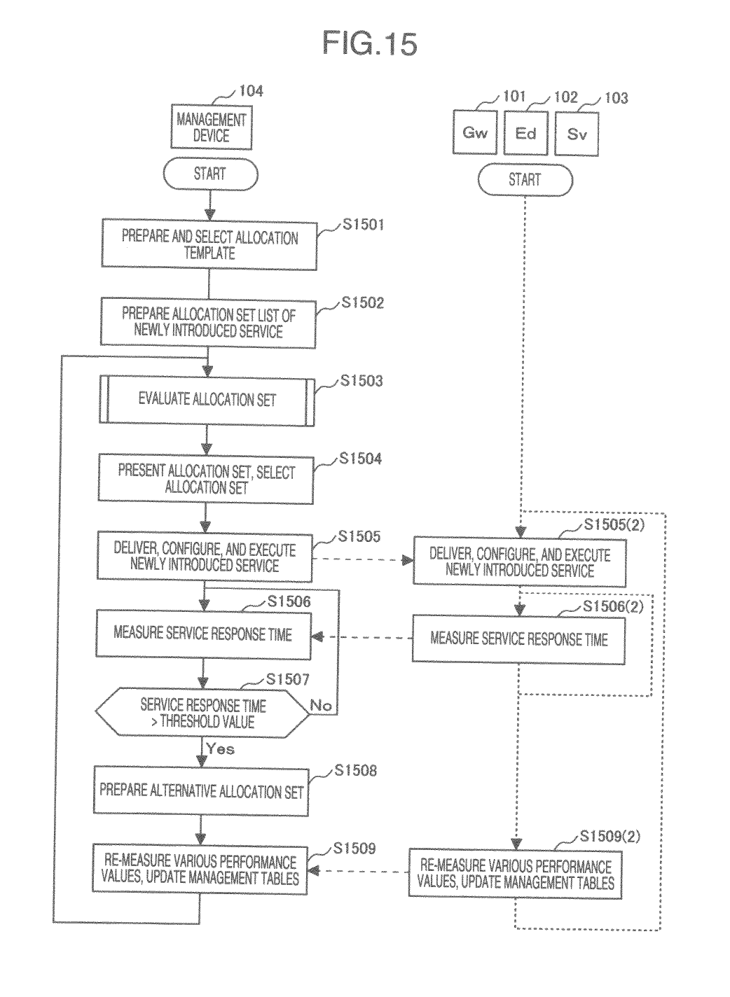

Next, description will be given of processing in which when the services exemplified in FIG. 3 are introduced as new services, the management device 104 deploys the services by allocating application programs to respective information processing devices on a wide-area network by using as indices the service response time, the system, power consumption, and the system operation step count. The respective programs of the management device 104 carry out this processing based on a dialog with the manager. FIG. 15 shows a processing flow of the management device 104 and that of the gateway node 101, the edge node 102, and the server processing 103.

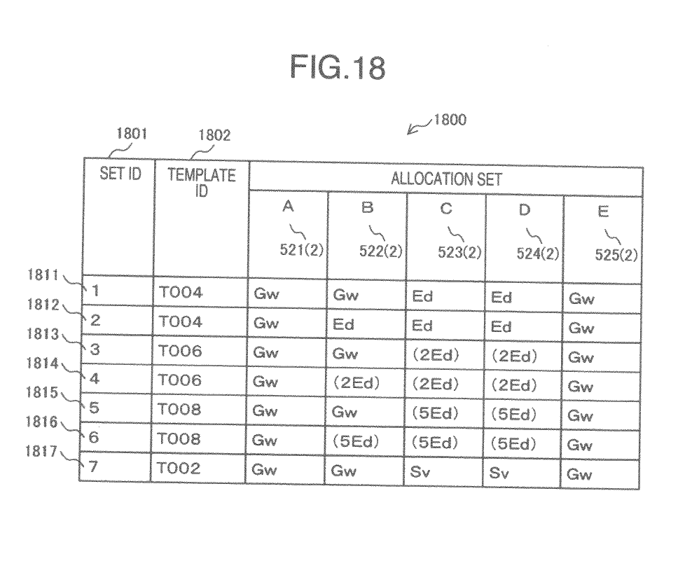

The allocation set preparing program 401 of the management device 104 prepares an allocation set list 1800 (FIG. 18) of application programs by use of the service attribute managing table 500.

Next, description will be given of an example in which application program allocation sets are prepared for three services of control of the traffic signal device 112, control of the lighting device 113, and control of the display device 114 exemplified in FIG. 3. Three allocation sets may be prepared respectively for these three services; or, a shared allocation set shared among these three services may be prepared. Hereinbelow, to avoid complexity of explanation, description will be given of a situation in which a shared allocation set is prepared. That is, the human identification program 306 and the people flow recognition program 309 are allocated in the same way as for the size recognition program 303. Hereinbelow, description thereof will be omitted for FIG. 18 and the like.

Similarly, the illumination configuration program 307 and the display information configuration program are allocated in the same way as for the alerting program 304, Hereinbelow, description thereof will be omitted for FIG. 18 and the like.

Moreover, the illumination configuration conversion program 308 and the display information conversion program 311 are allocated in the same way as for the alert conversion program 305. Hereinbelow, description thereof will be omitted for FIG. 18 and the like.

Incidentally, when the application allocation sets are individually prepared for the services of control of the traffic signal device 112, control of the lighting device 113, and control of the display device 114, it is only required that each service is treated as an independent service and processing of FIG. 15, which will be described later, is executed for each, service.

Each application program, constituting the services may be allocated, among the three-layer information processing devices (the gateway node 101, the edge node 102, and the server device 103), to any information processing device designated by the allocatable information processing device column (508, 509, 510) of the service attribute managing table 500.

As the number of application programs constituting a service increases, the number of allocatable combinations of application programs becomes larger and more complex. Hence, the allocation set preparing program 401 presents, as allocation templates, allocation along representative communication paths to the manager, and the manager selects therefrom allocation templates meeting service requirements (S1501).

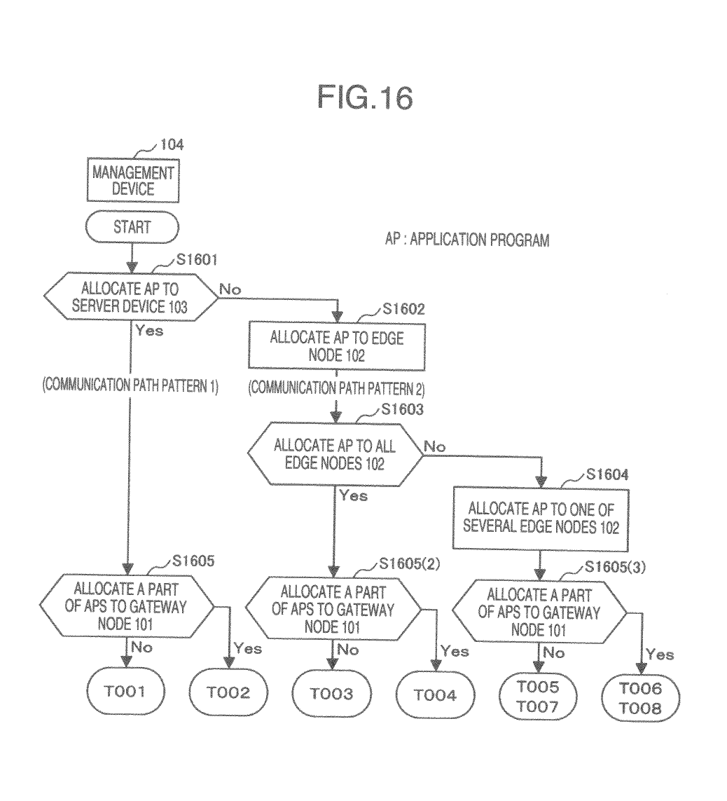

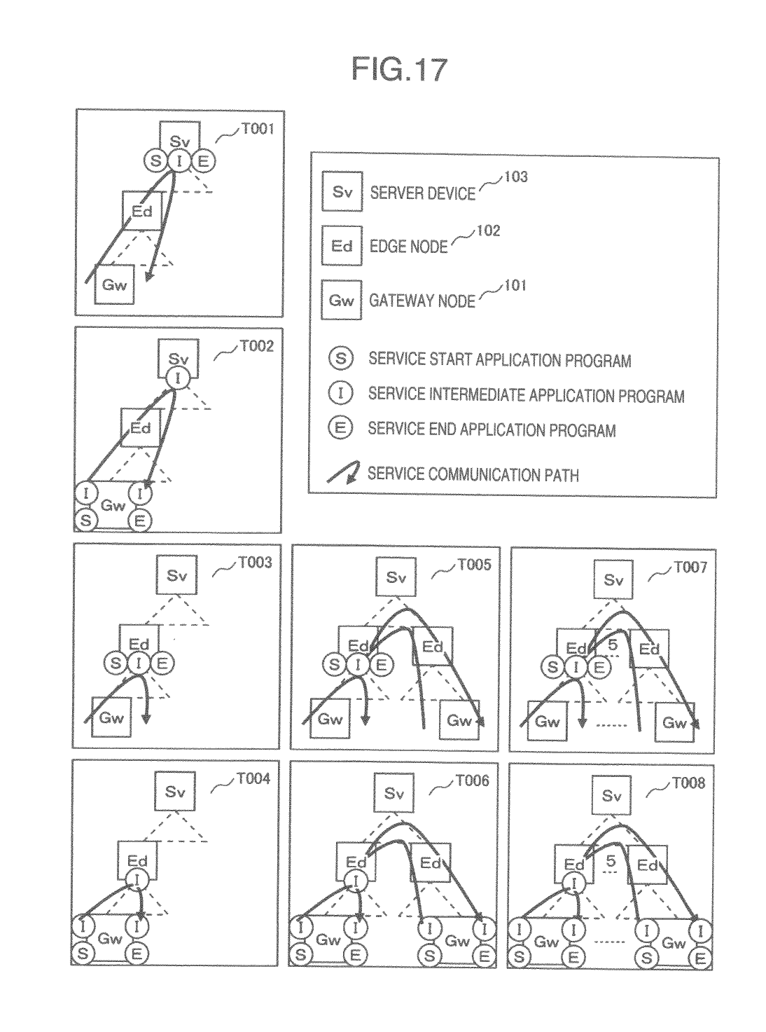

FIG 16 shows a procedure to create allocation templates. FIG 17 shows templates created as a result thereof. Communication paths of the service stipulated by the allocation templates are of two patterns as below.
1. Turn at server device 103 (communication path pattern 1)
Gateway node 101—Edge node 102—Server device 103—Edge node 102—Gateway node 101
2. Turn at edge node 102 (communication path pattern 2)
Gateway node 101—Edge node 102—Gateway node 101
Gateway node 101—Edge node 102—Edge node 102(2)—Edge node 102—Gateway node 101

The application programs constituting the service are sequentially allocated to the respective information processing devices existing on these communication path patterns 1 and 2. Whether the gateway node 101 as the service start point is equal to or unequal to the gateway node 101 as the service end point depends on the service provided.

The allocation template creation procedure includes three conditional branches as below.
Whether an application program (AP) of the service is allocated to the server device 103 (communication path pattern 1) or to the edge node 102 (communication path pattern 2) (S1601, S1602).
If the application program of the service is allocated to the edge node 102, whether the application program is allocated to all edge nodes 102 or to each group of several ones of the edge nodes 102 (S1603, S1604).
Whether or not an application program (the start application program, the end application program, or the like) allocatable to the gateway node 101 in the service is allocated to the gateway node 101 (S1605, S1605(2), S1605(3))

FIG 17 shows allocation templates created as a result of the processing. As examples of situations in which the application program is allocated to each group of several ones of the edge nodes 102, there are shown a situation in which the program is allocated to every second edge node (T005, T006) and a situation in which the program is allocated to every fifth edge node (T007, T008). The templates of FIG. 17 are as follows.
(T001): A start application program (to be abbreviated as AP), an intermediate AP, and an end AP of the service are allocated to the server device 103 (the number of respective APs: the number of server devices 103=1:1)
(T002): A start application program, a part of intermediate APs after the start AP, a part of intermediate APs before an end AP, and an end AP of the service are allocated to the gateway node 101 (however, the intermediate AP is not necessarily required) (the number of respective APs: the number of gateway nodes 101=1:1). Further, a part of intermediate APs is allocated to the server device 103 (the number of respective APs: the number of server devices 103=1:1)
(T003): A start application, program, an intermediate AP, and an end AP of the service are allocated to the edge node 102 (the number of respective APs: the number of edge nodes 102=1:1)
(T004): A start application program, a part of intermediate APs after the start AP, a part of intermediate APs before an end AP, and a service end AP of the service are allocated to the gateway node 101 (however, the intermediate AP is not necessarily required) (the number of respective APs: the number of gateway nodes 101=1:1). Further, a part of intermediate APs is allocated to the edge node 102 (the number of respective APs: the number of edge nodes 102=1:1)
(T005): A start application program. an intermediate AP, and a service end AP of the service are allocated to every second edge node 102 (the number of respective APs: the number of edge nodes 102=1:2)
(T006): A start application program AP, a part of intermediate APs after the start AP a part of intermediate APs before an end AP, and a service end AP of the service are allocated to the gateway node 101 (however, the intermediate AP is not necessarily required) (the number of respective APs: the number of gateway nodes 101=1:1). Further, a part of intermediate APs is allocated to every second edge node 102 (the number of respective APs: the number of edge nodes 102=1:2)
(T007): A application program, an intermediate AP, and an end AP of the service are allocated to every fifth edge node 102 (the number of respective APs: the number of edge nodes 102=1:5)
(T008): A start application program, a part of intermediate APs after the start AP, a part of intermediate APs before an end AP, and an end AP of the service are allocated to the gateway node 101 (however, the intermediate AP is not necessarily required) (the number of respective APs: the number of gateway nodes 101=1:1). Further, a part of intermediate APs is allocated to every fifth edge node 102 (the number of respective APs: the number of edge nodes 102=1:5)

From the templates described above, the manager selects several appropriate templates in consideration of the service requirements, the design step count, and the operation step count. Here, it is assumed that the manager selects the allocation templates (T002), (T004), (T006), and (T008) on the assumption that the processing is executed in the gateway node 101 (the service start and end application programs are allocated to the gateway node 101).

The allocation set preparing program 401 prepares, based on the allocation templates selected by the manager, combinations of application program allocation for the newly introduced service (S1502). The allocation set preparing program 401 refers to the allocatable information processing device (508 column, 509 column, 510 column) of the service attribute managing table 500 and lists all combinations of application program allocation conforming to the allocation templates, in the application program allocation set list 1800 shown in FIG. 18.

The allocation set list 1800 is created for each service. It includes respective columns such as a set ID column 1801, a template ID column 1802, and columns of application program allocation sets ranging from the 521(2) column to the 525 column.

To the set ID column 1801, there is set the identifier of an allocation set of

application programs constituting the service. This is the main key of the allocation set list.

To the template ID column 1802, there is set the identifier (a symbol of the template of FIG. 17) of the template assumed as the base of the allocation combination indicated by the row.

To respective columns from the 521(2) column to the 525 column, there are set types of information processing devices to be allocated respectively to the application programs ranging from an application program (ID=A(521(2)) to an application program (ID=E(525(2)). When an application program is allocated to the gateway 101, “Gw” is set. Similarly, when an application program is allocated to the server device 103, “Sv” is set. Further, when an application program is allocated to each edge node 102, “Ed” is set; when an application program is allocated to every second edge node 102, “(2Ed)” is set; and when an application program is allocated to every fifth edge node 102, “(5Ed)” is set.

Incidentally, it is also possible that the manager freely designates an application allocation set without designating an allocation template to add it to the allocation sets listed in the application program allocation set list 1800 by the allocation set preparing program 401. The allocation set designated by the manager is configured, for example, as below: one intermediate application program is allocated to all edge nodes 102 and another intermediate application program is allocated to every fifth edge node 102 in the service. Also, it is configured such that an intermediate application program is allocated to every second edge node 102 and another intermediate application program is allocated to the server device 103 in the service.

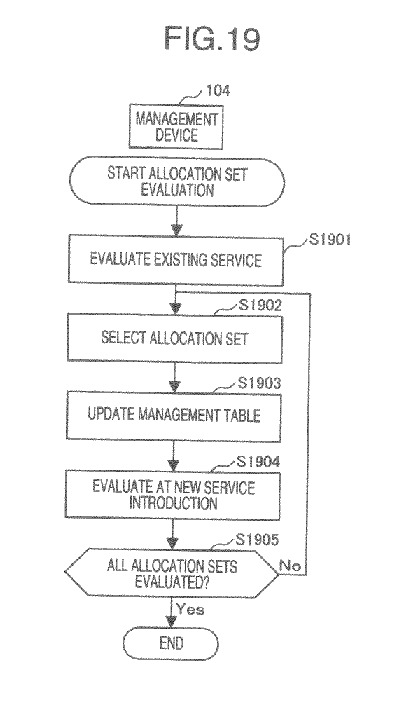

Next, the allocation set evaluating program 402 of the management device 104 calculates the service response time, the system power consumption, and the system operation step count for the application program allocation set prepared by the allocation, set preparing program 401 (S1503). FIG. 19 shows details of the processing.

First, the allocation set evaluating program 402 calculates the system power consumption and the system operation step count for an existing service (S1901). A plurality of existing services may be executed.

The system power consumption is calculated using expression 1.

$$\begin{matrix}[ MATH . 1 ] & \\ {\sum }_{l} {PTlink}_{l} \times {ATlink}_{l} + {\sum }_{n} {PTnode}_{n} \times {ATnode}_{n} + {\sum }_{n} {PPnode}_{n} \times {APnode}_{n} & ( expression 1 )\end{matrix}$$

In expression 1, the first term is power consumed in all communication paths at execution of an existing service. The second term is power consumption associated with data transfers in all information processing devices. The third term is power consumption associated with data processing in all information processing devices. Therefore, the first term of expression 1 is power consumed in all communication paths at execution of the existing service, and the sum of the second term and the third term is power consumed in all information processing devices.

In expression 1, PTlink 1 is power consumption in a path (path ID 801=1). A search is made through the path managing table 800 for the type 802 and the hop count 803 in the row for which the path ID 801 is 1. Further, a search is made through, the path power consumption managing table 1100 for power consumption of one hop 1101 corresponding to the type 802(2). By multiplying the path hop count 803 of the path by the power consumption of one hop 1101, the power consumption of the path is calculated.

ATlink 1 is a data transfer allocation state on a path (path ID 801=1). Using the service ID 1201(3) as a key, a search is made through the service communication path managing table 1400 for the information processing devices (device ID) (1402-1407) existing on the communication path of the existing service. Moreover, by using the device ID 601(2) as a key, a search is made through the link managing table 900 for a communication path (communication path ID 801(2)) between the information processing devices. The search result corresponds to the communication path (the communication path on which the data transfer is being conducted) of the existing service. If communication path (communication path ID 801=1) includes one or more communication paths of the existing service, ATlink 1=1; and if it is not employed as the communication path of the existing service at all, ATlink 1=0.

PTnode n is power consumption for the data transfer in the information processing device (device ID 601=n). A search is made through the table for managing information device 600 for the model 604 of the row for which the device ID 601 is n. In addition, a search is made through the information processing device power consumption managing table 1000 for the power consumption 1002 at use of the router function for the model 604(3), to assume it as the power consumption for the data transfer.

ATnode n is the data transfer allocation state in the information processing device (device ID 601=n). Using the service ID 1201(3) as a key, a search is made through the service communication path managing table 1400 for the device IDs (1402-1407) of information processing devices existing on the communication path of the existing service. Further, by use of the service ID 1201(2) as a key, a search is made through the allocation managing table 1300 for the device IDs (1302-1307) of the information processing devices to which application programs are allocated for the execution of the existing service. An information processing device which exists on the communication path of the service and to which no application program is allocated is the information processing device conducting the data transfer for the existing service. If the information processing device (device ID 601=n) is conducting the data transfer for one or more existing services, ATnode n=1; if it is not conducting the data transfer for any existing service at all, ATnode n=0.

PPnode n is the power consumption for data processing in the information processing device (device ID 601=n). A search is made through the table for managing information device 600 for the model 604 of the row for which the device ID 601 is n. In addition, a search is made through the information processing device power consumption managing table 1000 for the power consumption (overall power consumption) 1001 at use of all functions for the model 604(3), to assume it as the power consumption for the data processing.

APnode n is the allocation state of application programs in the information processing device (device ID 601=n). By use of the service ID 1201(2) as a key, a search is made through the allocation managing table 1300 for the device IDs (1302-1307) of the information processing devices to which application programs are allocated for the execution of the existing service. If one or more application programs of the existing service is or are allocated to the information processing device (device ID 601=n), APnode n=1; if no application program of the existing service is allocated thereto, APnode n=0.

The system operation step count is calculated using expression 2. The system operation is to implement system maintenance and management so that the system including the gateway node 101, the edge node 102, and the server device 103 exemplified in FIG. 1 provides services without halting for a period of time equal to or more than a predetermined period of time.

The system operation step count is the amount of jobs required for the system operation. It may be considered that the amount of jobs required to provide a service is proportional to the number of information processing devices for which management of application programs is required to provide the service. Therefore, the allocation set evaluating program 402 indicates the system operation step count by use of the number of information processing devices for which management of application programs is required to provide the service, that is, the number of information processing devices to which application programs are allocated to provide the service.

$$\begin{matrix}[ MATH . 2 ] & \\ {\sum }_{n} {APnode}_{n} & ( expression 2 )\end{matrix}$$

APnode n in expression 2 is similar to APnode n in expression 1.

Next, the allocation, set evaluating program 402 evaluates the service at introduction thereof for each new application program allocation set. First, the allocation set evaluating program 402 selects one row (one allocation set of application programs associated with the new service) from the application program allocation set list 1800 for the new service (S1902).

Based on the allocation set of the row selected in (S1902), the allocation set evaluating program 402 updates the allocation set managing table 1200, the allocation managing table 1300, and the service communication path, managing table 1400 (S1903).

The allocation set evaluating program 402 adds, to the allocation set managing table 1200, the service ID 1201 and the application program allocation set (1202-1207) associated with the newly introduced service. The manager indicates the configuration contents of the service ID 1201. Similarly, the allocation set evaluating program 402 adds, to the allocation managing table 1300, the deployment ID 1301 and the device IDs (1302-1307) of the information processing devices allocation regarding all deployments of the newly introduced service. The manager indicates the configuration contents of the deployment ID 1301 and the device IDs (1302-1307). Further, the allocation set evaluating program 402 adds, to the service communication path managing table 1400, the data input frequency 1401 and the device IDs (1402-1407) of the information processing devices on the communication path information associated with all deployments of the newly introduced service. The manager indicates the configuration contents of the data input frequency 1401 and the device IDs (1402-1407).

Next, the allocation set evaluating program 402 calculates, by use of the various management tables updated in (S1903), the service response time, the system power consumption, and the system operation step count at introduction of the new service (S1904).

The allocation set evaluating program 402 predicts the service response time for the newly introduced service. The service response time is calculated using expression 3.

$$\begin{matrix}[ MATH . 3 ] & \\ \frac{1}{M} {\sum }_{sid = 1}^{M} ( {\sum }_{sl} {Dlink}_{sl} ) + \frac{1}{M} {\sum }_{sid = 1}^{M} ( {\sum }_{sn} {Dnode}_{sn} ) ( 1 ) & ( expression 3 ) \\ {Dlink}_{sl} = \frac{{s}_{sl , sid}}{b {w}_{sl}} + {delay}_{sl} ( 2 ) \\ {Dnode}_{sn} = \frac{1 / {μ}_{sn}}{1 - {λ}_{sn} / {μ}_{sn}} ( 3 ) & \end{matrix}$$

The first term of expression 3(1) is the delay time, included in the service response time, on the communication, path at execution of the service (deployment number M). The second terns is the delay time, included in the service response time, in the information processing device. Although details will be described later, the delay time on the communication path is represented by the sum of the transmission delay time of data on the communication path and the propagation delay time on the communication path; and the delay time in the information processing device is represented by the data buffering delay time in the information processing device.

In expression 3 (1), Dlink sl in the parentheses of the first term is the delay time of the communication path (communication path ID 801=sl) for one deployment (deployment ID 1301=sid) of the service. In the first term, the item in the first parentheses is the delay time in all communication paths for the deployment (deployment ID 1301=sid). The first term is the mean value of the delay time in the all communication paths for the service of the deployment number M.

In expression 3 (1), Dnode sn in the parentheses of the second term is the delay time of the information processing device (device ID 601=sn) on the communication path for one deployment (deployment ID 1301 =sid) of the service. In the second term, the item in the parentheses is the delay time in all information processing devices on the communication path for the deployment (deployment ID 1301=sid) of the service. The delay time in an information processing device includes the delay for the data transfer and the delay for the data processing. The second term is the mean value of the delay time in all information processing devices on the communication path for the service of the deployment number M.

In the description of expressions 3(2) and 3(3) below, the row of (deployment ID 1301=2-00002(1321)) in the allocation managing table 1300 and the row of (deployment ID 1301(2)=2-00002(1321(2)) in the service communication path managing table 1400 are assumed to represent one deployment of the newly introduced service, and this deployment is used as an example for explanation.

In expression 3(1), Dlink sl in the parentheses of the first term is calculated using expression 3(2).

The first term of expression 3(2) is the transmission delay time of data to one communication path (communication path ID 801=sl) in one deployment (deployment ID 1301=sid) of the service. In expression 3(2), s sl,sid of the first term is the output data amount to one communication path (communication path ID 801=sl) in one deployment (deployment ID 1301=sid) of the service. The communication path between the gateway node 101 (device ID 601=G00002 (1322(2))) and the edge node 102 (device ID 601=E00010 (1421))) will be adopted as an example. The path ID 801 of this communication path can be obtained by making a search through the link managing table 900 by using, as a key, the gateway node 101 (device ID 601=G00002 (1322(2))) and the edge node 102 (device ID 601=E00010 (1421)). The output data amount to the communication path can be obtained by retrieving the output data amount of the application program (ID=A(1302)) allocated to the gateway node 101 (device ID 601=G00002 (1322(2)) from the service attribute managing table 500 (the output data amount column 1 Mbytes (531) of the row of ID=A(521)). This similarly applies to the other communication paths of the pertinent deployment (deployment ID 1301(2)=2-00002(1321(2)).

In the first term of expression 3(2), bw sl is the band of the communication path (communication path ID 801=sl). By using, as an example, the communication path between the gateway node 101 (device ID 601=G00002 (1322(2))) and the edge node 102 (device ID 601=E00010 (1421))), the band of this communication path is obtainable by searching the path managing table 800 using the path ID 801 as a key for the band column 805. This similarly applies to the other communication paths of the deployment (deployment ID 1301(2)=2-00002 (1321(2)).

In the second term of expression 3(2), delay sl is the propagation delay time of the communication path (communication path ID 801=sl). In consideration of the communication path between the gateway node 101 (device ID 601=G00002 (1322(2))) and the edge node 102 (device ID 601=E00010 (1421))), the propagation delay time of the communication path is obtainable by searching the path managing table 800 using the path ID 801 as a key for the propagation delay time column 804. This similarly applies to the other communication paths of the deployment (deployment ID 1301(2)=2-00002 (1321(2)).

Expression 3(3) represents the data buffering delay time in the information

processing device (device ID 601=sn). There is employed an M/M/1 waiting line model described in “The Art of Computer Systems Performance Analysis” (written by R. Jain, John Wiley & Sons, Inc., 1991, ISBN:978-0471503361) and the like.

η sn is the mean input data amount per unitary time of data inputted to the information processing device (device ID 601=sn).

Description will be given by using, as an example, the edge node (device ID 601=E00001 (1323(2))) of the deployment (deployment ID 1301(2)=2-00002 (1321(2))) in the service communication path managing table 1400. The information processing device (abbreviated as the input device) to output input data to the edge node (device ID 601=E00001 (1323(2))) is obtainable by making a search through the service communication path managing table 1400 for all rows containing (device ID 601=E00001(1323(2))) for the information processing devices (1402 column-1407 column) on the service communication path.

From the information processing devices (1402 column-1407 column) on the service communication path of the searched row, there is obtained device ID 601 of an information processing device which is on the left side of (device ID 601=E00001 (1323(2))) and to which an application program is allocated. For example, one of the input devices is the gateway node 101 (device ID 601=G00001 (1332(2)) in the row of (deployment ID 1301(2)=2-00001 (1331(2)).

To determine whether or not an application program is allocated to the information processing device and what is the ID of the application program, the allocation managing table 1300 is referred to. In the example of the gateway node 101 (device ID 601=G00001 (1332(2)), by use of the gateway node 101 (device ID 601=G00001 (1332)) in the row of (deployment ID 1301=2-00001 (1331) of the allocation managing table 1300, it is determined that the ID of the application program is A 1302.

The input data amount per unitary time of each input device is obtainable by referring to the data input frequency 1401 column of the searched row and to the output data amount column 506 and the input and output frequency ratio column 507 of the service attribute managing table 500. In the example of the edge node (device ID 601=G00001 (1323(2)), if (service ID 1201=2) is a service managed by the service attribute managing table 500, 20 items/sec (1431)×1 Mbyte (531)×1 (532)=20 Mbyte/sec. Such value is summed up for all input devices to obtain the mean input data amount per unitary time of data to the edge node 102 (device ID 601=E00001(1323(2))).

λ sn is the data processing performance (amount of data which can be processed per unitary time) of the information processing device (device ID 601=sn).

When an application program is allocated to the information processing device (device ED 601=sn), the data processing performance is the minimum value of the processing performance of server function 701 and the processing performance of router function 702 retrieved from the information processing device performance managing table 700 and the performance of the path to which the information processing device (device ID 601=sn) outputs data (obtained by referring to the bandwidth column 805 of the path managing table 800).

When no application program is allocated to the information processing device (device ID601=sn), the data processing performance is the value of the smaller one of the processing performance of router function 702 retrieved from the information processing device performance managing table 700 and the performance of the path to which the information processing device (device ID 601=sn) outputs data (obtained by referring to the bandwidth column 805 of the path managing table 800).

The calculations of the system power consumption and the system operation step count are similar to the calculation at evaluation of the existing service (S1901).

The allocation set evaluating program 402 confirms whether or not all rows have been selected from the application program allocation set list 1800 for the new service (S1905).

If ail rows have been selected, the program 402 terminates processing in this state; if there remains any row to be processed, the program 402 returns again to (S1902) to evaluate the service for the application program allocation set not selected from the application allocation set list 1800.

Incidentally, if the management table is to be updated again in (S1903), the contents of the application program allocation set previously inputted are deleted and then the processing is executed for an application program allocation set selected anew.

Next, the allocation set selecting program 403 of the management device 104 evaluates the results calculated by the allocation set evaluating program 402, selects candidates of appropriate allocation sets from the application program allocation set list of the newly introduced service, and presents them to the manager. The manager selects an optimal allocation set from the candidates (S1504).

The allocation set selecting program 403 displays, in the selection of allocation set candidates, the calculation results of the service response time, the system power consumption, and the system operation step count in graphs, to clearly present reasons for the

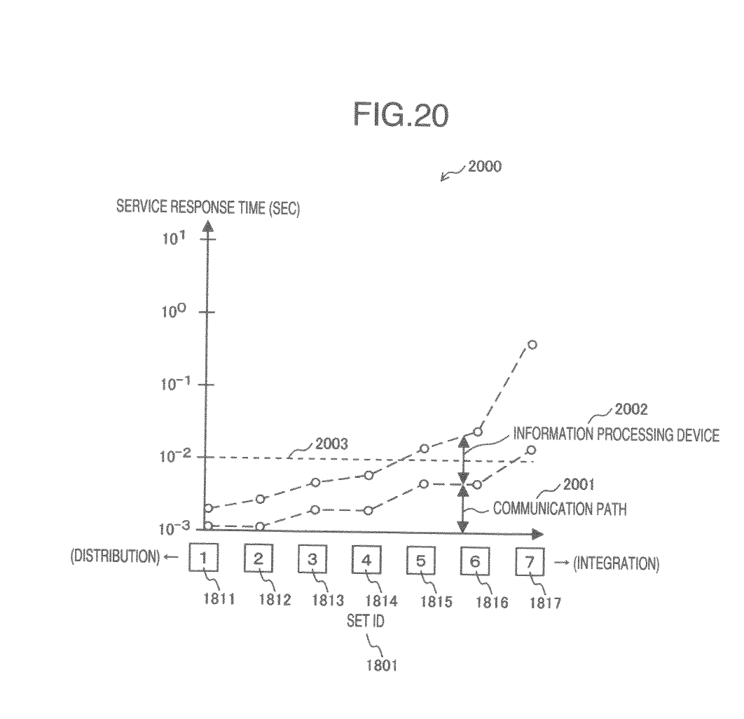

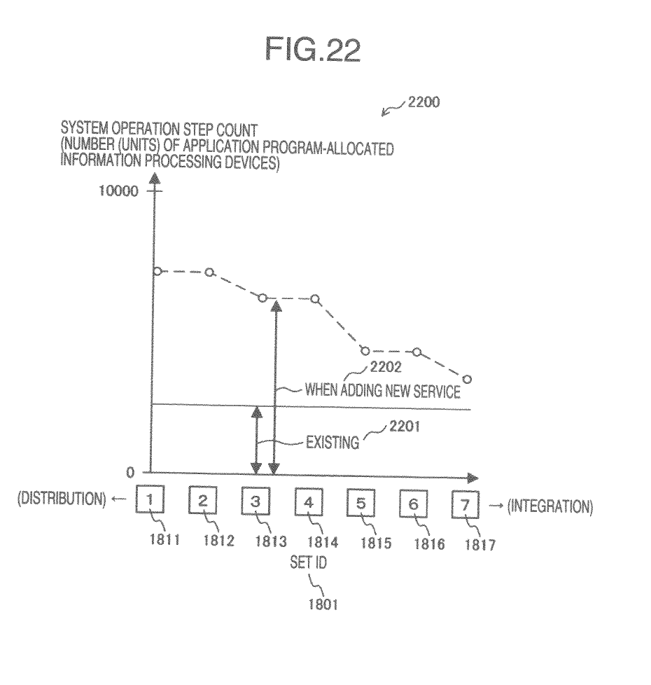

selection of candidates to the manager Examples of graphs displayed are shown in FIGS. 20 to 22.

FIG. 20 shows a display example of the calculation results of the service response time. In the graph 2000, the abscissa represents the set ID 1801 of the application program allocation set list 1800. The graph 2000 shows, for each allocation set, the calculation results of the service response time for the newly introduced service implemented in (S1503). The service response time is the sum of the delay time 2001 on the communication path corresponding to the first term of expression 3(1) and the delay time 2002 in the information processing device corresponding to the second term of expression 3(1), and they are separately shown.

In the system configuration of the present embodiment shown in FIG. 1, the delay time 2001 on the communication path tends to be shorter in the situation (of the communication path pattern 2) in which the processing is executed at a position (the network delay time is shorter) near the client device branch office 131. For the communication path pattern 2, the processing is distributively executed in many edge nodes 102; hence, the delay time 2002 in the information processing device similarly tends to be shorter.

The line 2003 parallel to the abscissa of the graph indicates the minimum value 0.01 sec 541 of the service response time column 511 of the service attribute managing table 500 for the newly introduced service. It is indicated that the allocation sets meeting the service response time requirements are allocation sets with set IDs ranging from set ID=1 (1811) to set ID=4 (1814).

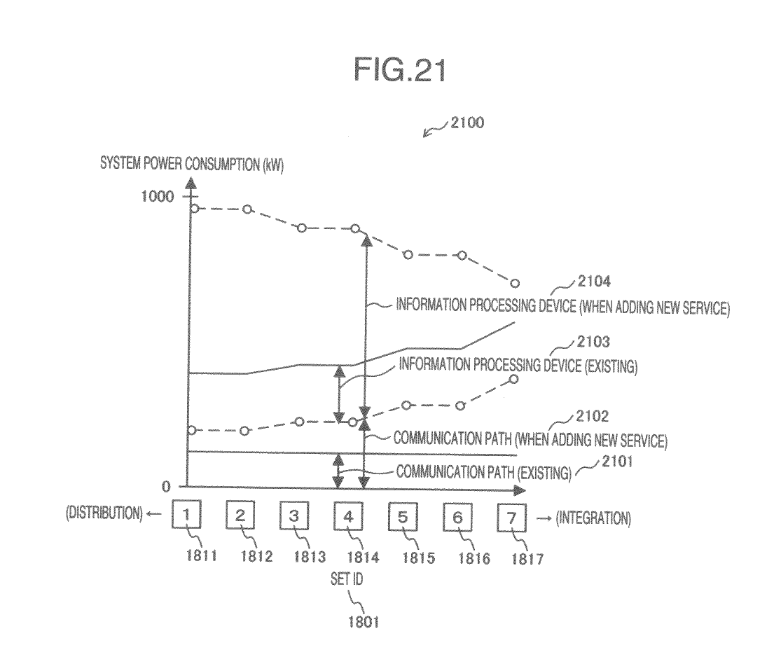

FIG. 21 is a display example of the calculation results of the system power consumption. The abscissa of the graph 2100 is similar to that of the graph 2000. The system power consumption is the sum of the power consumption 2102 on the communication path corresponding to the first term of expression 1 and the power consumption 2104 in information processing device corresponding to the sum of the second and third terms of expression 1, and they are separately shown.

The power consumption 2102 on the communication path is the power consumption at introduction of a new service, and the power consumption 2101 when no new service is introduced is also displayed. Similarly, the power consumption 2104 in information processing device is the power consumption at introduction of a new service, and the power consumption 2103 when no new service is introduced is also displayed.

In the system configuration of the present embodiment shown in FIG. 1, the power consumption 2102 on the communication path tends to be smaller in the situation (of the communication path pattern 2) in which the processing is executed at a position (the network delay time is shorter) near the client device branch office 131. On the other hand, for the communication path pattern 2, the processing is distributively executed in many edge nodes 102; hence, the power consumption 2104 in information processing device tends to be increased.

FIG, 22 is a display example of the calculation results of the system operation step count. The abscissa of the graph 2200 is similar to those of the graphs 2000 and 2100. The system operation step count is indicated, as already described, by the number of information processing devices to which application programs have been, allocated, and corresponds to expression 2.

The system operation step count 2202 is the number of operation steps at introduction of a new service, and the system operation step count 2201 when no new service is introduced is also displayed.

In the system configuration of the present embodiment shown in FIG 1, in the situation (of the communication path pattern 2) in which the processing Is executed at a position (the network delay time is shorter) near the client device branch office 131, the processing is distributively executed in many edge nodes 102; hence, the system operation step count 2202 tends to be increased.

As above, in the system configuration of the present embodiment shown in FIG. 1, in the situation (of the communication path pattern 2) in which the processing is executed at a position (the network delay time is shorter) near the client device branch office 131, the delay time 2001 on the communication path tends to be shorter, similarly, the power consumption 2102 on the communication path also tends to be smaller.

For the communication path pattern 2, the processing is distributively executed in many edge nodes 102; hence, the delay time 2002 in the information processing device tends to be shorter; however, the power consumption 2104 and the system operation step count 2202 in the information processing device tend to be increased. In this situation, the allocation set selecting program 403 comprehensively evaluates these calculation results based on which one of the aspects is to be regarded as important, to thereby select one or more allocation sets,

The allocation set selecting program 403 indicates, based on the service response time calculation graph 2000, that the allocation sets meeting the service response time requirements (the service response time is smaller as compared with the line 2003) ranges from the allocation set with set ID 1801=1 (1811) to the allocation set with set ID 1801=4 (1814), Further, the program 403 selects therefrom an allocation set with, set ID 1801=3 (1813) and an allocation set with set ID 1801=4 (1814) which are smaller in the system power consumption and the system operation step count, and presents them as allocation set candidates to the manager. Here, a plurality of candidates are presented so that the manager selects a candidate in consideration of requirements in addition to the requirements of the service response tune, the system power consumption, and the system operation step count.

The manager selects therefrom an allocation set regarded as optimal. Assume

that the manager selects, for example, an allocation set indicated by set ID 1801=3 (1813). To introduce a new service, the service introducing program 404 of the management device 104 indicates delivery, configuration, and execution of application programs to the information processing devices (the gateway node 101, the edge node 102, the server device 103) (S1505).

First, based on the application program allocation set selected by the manager, the service introducing program 404 updates the allocation set managing table 1200, the allocation managing table 1300, and the service communication path managing table 1400. This processing is similar to the processing described for (S1902).

The service introducing program 404 refers to the allocation managing table 1300, delivers an application program to an information processing device as the target of allocation, and updates the configuration file of the target information processing device. Moreover, the program 404 refers to the service communication path managing table 1400 and updates the configuration file of any information processing device which is not the target of application program allocation and which exists on the communication path of the service. Thereafter, the service introducing program 404 indicates execution of the service to each information processing device for which the configuration is implemented.

The service response time monitoring program 405 of the management device 104 monitors the service response time of the new service being executed (S1506).

The service response time is measured by the gateway node 101 through the processing described by referring to FIG. 3. The management device 104 periodically obtains results of the measurement from the gateway node 101 to thereby monitor the service response time. Incidentally, to measure the service response time, each information processing device and each management device repetitiously (for example, periodically) conduct synchronization with respect to time by use of a measure such as the Network Time Protocol (NTP).

When the measured result of the service response time is compared with a threshold value (S1507) and if the result is more than the threshold value (not satisfying the criterion), the alternative allocation set selecting program 406 of the management device 104 presents alternative allocation sets to the manager (S1508).

If the manager has selected in (S1504) an allocation set indicated by set II) 1801=3 (1813) from the application program allocation set list 1800, the alternative allocation set selecting program 406 selects, based on the results of the service response time evaluation calculation graph 2000, the allocation sets with set ID 1801=1 (1811) and set ID 1801=2 (1812) which are shorter in the service response time, and presents them as the alternative allocation set candidates to the manager. Here, a plurality of candidates are presented so that the manager selects a candidate therefrom.

Incidentally, since the service response time for set ID 1801=3 differs from the original prediction and exceeds the threshold value, there are selected, by referring to FIG. 18, set ID 1801=1 and set ID 1801=2, which are shorter in the service response time than set ID 1801=3, as the alternative allocation set candidates. Since set ID 1801=4 presented as the first allocation set candidate is longer in the service response time than set ID 1801=3, it is not employed as the alternative candidate.

If the actual measurement result of the service response time differs from the evaluation results of the service response time first obtained in (S1503) and exceeds the threshold value (not satisfying the criterion), it is likely that values in at least one of the service attribute managing table 500, the information processing device performance managing table 700, the path managing table 800, the information processing device power consumption managing table 1000, and the path power consumption managing table 1100 employed to calculate the service response time, the system power consumption, and the system operation step count in (S1503) differ from actual values. The service response time of each of the allocation sets with set ID 1801=1 (1811) and ID 1801=2 (1812) is to be less than that of set ID 1801=3 (1813): however, it is required, by investigating the values of the respective management tables, to return to (S1503) to re-evaluate whether or not the service response time is less than the threshold value (satisfies the criterion).

In this situation, before conducting the re-evaluation in (S1503), the management device 104 acquires performance information and the like from the respective information processing devices to re-measure a re-evaluation relevant part of or all of the value of the input and output frequency ratio column 507 of the service attribute managing table 500, the values of the processing performance columns (701, 702) of the information processing device performance managing table 700, the values of the propagation delay time column 804 and the bandwidth column 805 of the path managing table 800, the values of the power consumption columns (1001, 1002) of the information processing device power consumption managing table 1000, and the value of the power consumption of one hop column 110 of the path power consumption managing table 1100. Based on the measured values, the manager updates values of the respective management tables according to necessity (S1509).

After (S1509), for the allocation sets with set ID 1801=1 (1811) and set ID 1801=2 (1812) presented by the alternative allocation set selecting program 406, control returns to (S1503) to again conduct the evaluation to substitute for a service beforehand introduced, according to necessity.

Incidentally, in the description above, the alternative allocation set selecting program 406 presents, if the measured result of the service response time is more than the threshold value, alternative allocation sets predicted to highly reduce the service application time; however, it is also possible that the program 406 presents, if the measured result of the service response time is less than the threshold value, alternative allocation sets which are predicted to satisfy the service response time requirements and which are predicted to reduce the system power consumption and the system operation step count.

As described above, in a situation in which services to process information by sequentially calling a plurality of application programs managed by the service attribute managing table 500 are introduced to the information processing devices (the gateway node 101, the edge node 102, the server device 103) geographically distributively deployed in the wide-area network (the backbone network 122 and the access network 121), the management device 104 in the embodying mode of the present invention prepares the allocation set list 1800 of application programs to the information processing devices; calculates the service response time, the system power consumption, and the system operation step count for each, allocation set (1811-1877) of the list 1800, evaluates the results thereof (the graph 2000, the graph 2100, the graph 2200), and presents candidates for selection of allocation sets (1813 and 1814 in the allocation set list 1800) to the manager.

Further, in a situation in which it is feared that after the service is introduced by use of the allocation set 1813, the service response time 511 of the service attribute managing table 500 is not satisfied, the management device 104 presents alternative allocation sets (1811 and 1812 in the allocation set list 1800), to thereby enable re-selection.

Therefore, it is possible to provide the service in the mode described above by reducing the system power consumption while satisfying the requirements as the criterion that the service is provided within the desired service response time. Moreover, it is possible to provide the service in the mode described above by reducing the service operation step count in addition to the system power consumption while satisfying the requirements as the criterion that the service is provided within the desired service response time.

### REFERENCE SIGNS LIST

101: Gateway node, 102: Edge node, 103: Server device, 104: Management device, S1501: Prepare and select allocation template, S1502: Prepare allocation set list for newly introduced service, S1503: Evaluate allocation set, S1504: Present allocation set, select allocation set, S1505, S1505(2): Deliver, configure, and execute newly introduced service, S1506, 81506(2): Measure service response time, S1507: Service response time>Threshold value, S1508: Prepare alternative allocation set, S1509, S1509(2): Re-measure various performance values, update management tables.

1. A service configuration support method performed by a management device in a distributed information processing system for providing a service through operation in which a plurality of information processing devices mutually coupled via a communication path with each other sequentially call and execute programs, wherein the management device:
prepares a plurality of allocation set evaluation candidates to be used for selecting one of allocation sets, each of which designates, for each of the plural programs to implement the service, an information processing device to execute the program;
calculates service response time and system power consumption of the service when each of the plural allocation set evaluation candidates is applied; and
evaluates results of the calculation, selects the allocation sets which satisfy desired service response time and which reduce the system power consumption, and presents the selected allocation sets as allocation set selection candidates.

2. The service configuration support method according to claim 1, wherein
the service response time is a sum of delay time in the information processing device and delay time in the communication path; and
the system power consumption is a sum of power consumption in the information processing device and power consumption in the communication path.

3. The service configuration support method according to claim 1, wherein the management device:
monitors service response time of a service provided based on an allocation set selected from the allocation set selection candidates;
re-evaluates the calculation results if the service response time being monitored does not satisfy a required criterion; and
selects and presents alternative allocation set selection candidates.

4. The service configuration support method according to claim 1, wherein the management device:
calculates a system operation step count based on the number of information processing devices to which the programs are allocated to provide the service; and
evaluates also the system operation step count at selection of the allocation sets or the alternative allocation sets.

5. The service configuration support method according to claim 1, wherein the management device:
prepares allocation sets of programs to information processing devices by use of program allocation templates stipulating communication paths of the service.

6. The service configuration support method according to claim 1, wherein:
in a situation in which the plural information processing devices to execute each of the plural programs to implement the service are divided into at least one first information processing device group, at least one second information processing device group, and at least one third information processing device group which controls an input device and/or an output device employed to provide the service,
the communication path includes a first communication path and a second communication path, delay times of which are used to calculate the service response time and power consumptions of which are used to calculate the system power consumption;
two arbitrary information processing devices included in the first information processing device group and the second information processing device group are coupled via the first communication path with each other; and
the information processing device included in the second information processing device group is coupled via the second communication path with the information processing device included in the third information processing device group.

7. The service configuration support method according to claim 6, wherein the management device prepares, in the preparing of the allocation set evaluation candidates,
the allocation set evaluation candidates in which the information processing devices included in the first information processing device group are not designated and/or the allocation set evaluation candidates in which the information processing devices included in the first information processing device group and the information processing devices included in the third information processing device group are not designated.

8. A distributed and layered type information processing system for providing a service implemented through operation in which a plurality of information processing devices distributively deployed in a network cooperatively conduct operations to thereby execute a plurality of programs, characterized by
designating, for each of the plural programs, one of the information processing devices to execute the program, by using service response time and system power consumption as indices.

9. The distributed and layered type information processing system according to claim 8, characterized by
designating, for each of the plural programs, one of the information processing devices to execute the program, by using, as indices, service response time and system power consumption of each of the information processing devices and each of the communication paths coupling the information processing devices with each other.
